(19) United States
(12) Patent Application Publication
(10) Pub. No.: US 2026/0364613 A1
(43) Pub. Date: Nov. 19, 2026

(54) SPRAY COMPONENT WITH THERMAL INSULATION LAYER FOR HIGH TEMPERATURE ENVIRONMENT

(71) Applicant: Spraying Systems Co., Weaton, IL (US)

(72) Inventors: Raymond Perry III, Derry, NH (US); Jason Tyler Rusch, Nashua, NH (US)

(21) Appl. No.: 19/677,734

(22) Filed: May 14, 2026

Related U.S. Application Data
(60) Provisional application No. 63/805,712, filed on May 14, 2025.

(51) Int. Cl. B05B 1/00; B05B 15/00; C04B 35/626; C04B 35/82

(52) U.S. Cl. CPC B05B 1/00; B05B 15/00; C04B 35/62625; C04B 35/82; C04B 2235/5232; C04B 2235/602; C04B 2235/9607

(57) ABSTRACT

A spray component includes a body including an internal fluid passageway. The internal fluid passageway communicating at one end with a discharge orifice. The ceramic thermal insulation layer is provided on an external surface of the body. The ceramic thermal insulation layer is a liquid applied, ceramic particle dispersion having at least one filler from the group consisting of a fibrous material and glass micro balloons.

### CROSS-REFERENCE TO RELATED APPLICATION

This patent application claims the benefit of U.S. Provisional Patent Application No. 63/805,712, filed May 14, 2025, which is incorporated by reference.

### BACKGROUND OF THE INVENTION

Discharging or injecting fluids in high-temperature environments can pose several issues. These issues can be particularly problematic in high-temperature environments where temperature-sensitive liquids such as sulfur, diesel exhaust fluid (DEF), oils, glues, biomass feedstocks and certain foods such as chocolate are used. These liquids are prone to crystallization or solidification when exposed to high surface temperatures such as can exist on surfaces of the injection system. This crystallization or solidification on surfaces of the injection system can result in clogging, fouling, and reduced performance or complete failure of the injection system.

One way in which to address this problem is providing the spray components exposed to the high-temperature environment with thermal insulation. However, conventional insulation systems are typically bulky, rigid, or difficult to apply particularly to the complex geometries of, for example, the injector tips and nozzle surfaces of the spray injection system. In some applications, such as those requiring steam jacketing, the lack of compact and easy-to-apply insulation can further complicate system design and maintenance.

### OBJECTS OF THE INVENTION

In view of the foregoing, a general object of the present invention is to provide spray components for high-temperature environments having a thin, easy to apply thermal insulation.

A further object of the present invention is to provide a spray component for high-temperature environments having a thermal insulation that can conform to intricate shapes.

Another object of the present invention is to provide a spray component for a high-temperature environment having a thermal insulation that extends the operational life of the spray component by, for example, reducing fluid crystallization or solidification on surfaces of the spray component.

Other objects and advantages of the invention will become apparent upon reading the following detailed description and upon reference to the drawings. The identified objects are not intended to limit the present invention.

### BRIEF DESCRIPTION OF THE SEVERAL VIEWS OF THE DRAWINGS

FIG. 1 is a partial side cross-sectional view of an illustrative spray component, in this case a spray gun, having a thermal insulation layer according to one aspect of the present disclosure.

FIG. 2 is a perspective view of an alternative embodiment of a spray component, in this case a spray nozzle, having a thermal insulation layer according to one aspect of the present disclosure.

FIG. 3 is a side cross-sectional view of the spray nozzle of FIG. 2.

FIG. 4 is a flow chart of an illustrative method for applying a thermal insulative coating to a spray component according to one aspect of the present disclosure.

FIG. 5 is a flow chart of an alternative embodiment of a method for applying a thermal insulative coating to a spray component according to one aspect of the present invention.

FIG. 6 is a perspective view of a component of a solid first mold for use in the method of FIG. 5.

FIG. 7 is a perspective view of a component of a mesh second mold for use in the method of FIG. 5.

### DETAILED DESCRIPTION OF THE INVENTION

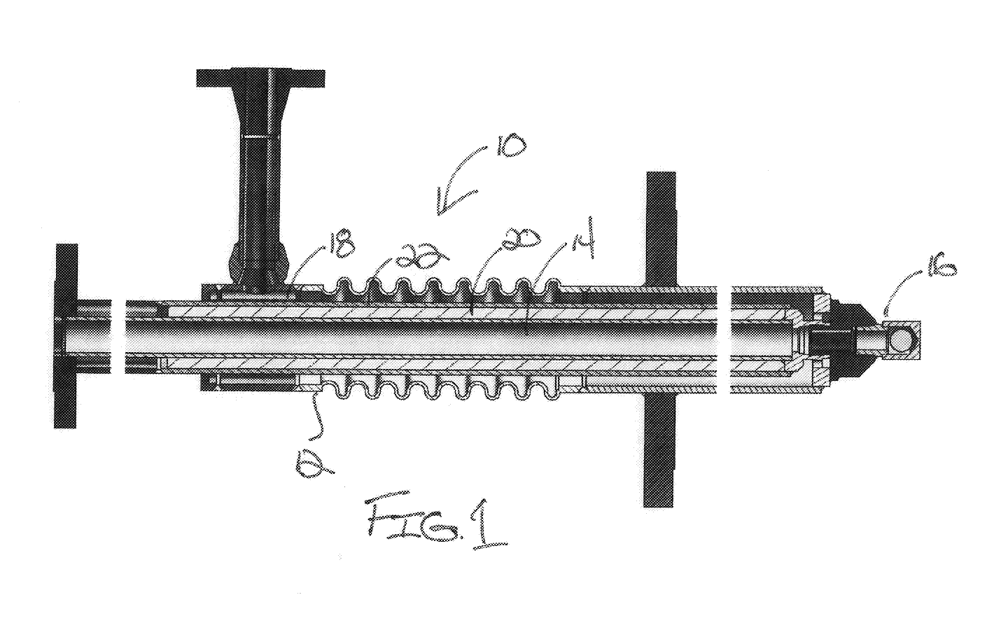

Referring to FIG. 1 of the drawings there is shown an illustrative spray component for use in high-temperature environments. In this case, the complete spray component is in the form of a spray gun or lance 10 that can be used to inject a liquid into a high temperature environment. The present disclosure is particularly useful in spray applications in which the fluid being injected or dispersed is temperature sensitive and prone to crystallize or solidify on surfaces having a high temperature, including on surfaces of the spray component itself. Some examples of such spray applications include injection of DEF into selective catalytic reduction (SCR) and selective non-catalytic reduction (SNCR) systems and injection of molten sulfur into a sulfur burning system. However, the present invention is not limited to use in any particular application and can be used in any application in which protection against thermal energy is desirable. Moreover, while aspects of the present invention are described in connection with the illustrated spray gun and spray nozzle, the invention is not limited to spray guns and instead can be implemented with respect to any spray component that is used in a high-temperature environment including, for example, spray tips, spray lances, and even headers or pipes used to direct fluid to components that discharge the fluid and holding tanks for storage of fluids.

According to one aspect of the present disclosure, the illustrated spray gun 10 may have a liquid-applied ceramic thermal insulation layer specifically designed for high-temperature applications involving temperature-sensitive liquid injection. The ceramic thermal insulation layer may be the so-called Ceramic coating material available from NanoTech Materials of Katy, Texas (www.nanotechmaterials.com). The NanoTech Ceramic coating material is a liquid dispersion that includes various additives including a ceramic material that NanoTech has referred to as an Insulative Ceramic Particle™ (ICP). NanoTech has also referred to the ceramic liquid dispersion as Refractory Shield. When applied on an appropriate substrate, this ceramic coating material becomes a solid thermally insulative film. Advantageously, the ceramic coating material can be uniformly applied to complex and irregular geometries, including the exterior surfaces of spray components such as spray guns, lances and spray nozzles, without compromising adhesion or performance thereby overcoming limitations of rigid or pre-formed insulation products. The ceramic coating material is chemically and thermally stable in high-temperature industrial environments, ensuring durability and long service life of the resultant ceramic thermal insulation layer or coating even under repeated thermal cycling. Thus, the ceramic thermal insulation layer improves upon existing insulation techniques by combining ease of application, compactness, and high thermal performance.

To adjust the properties of the liquid ceramic coating material and/or to facilitate the application of the coating material, various additives or fillers may be included in or added to the liquid dispersion. These fillers may include, for example, fiberglass, carbon fiber and/or glass micro balloons. In some embodiments, the fillers may be selected to adjust the properties of the resultant ceramic thermal coating to provide, for example, additional strength and/or durability or to facilitate application of the liquid ceramic coating material to a surface of a spray component.

In the illustrated embodiment, the spray gun 10 includes a housing 12 that surrounds a body which in this case is an inner liquid feed tube 14 that directs fluid to a discharge nozzle 16 arranged at one end of the housing 12. The illustrated spray gun 10 further includes an atomizing gas passageway 18 that surrounds the inner liquid feed tube 14 and directs atomizing gas to the discharge nozzle 16. However, not all spray guns to which this invention is applicable utilize atomizing gas. In this case, a ceramic thermal insulation layer 20 is provided on the outer surface of the inner liquid feed tube 14. The illustrated spray gun 10 further includes a protective outer casing 22 surrounding the ceramic thermal insulation layer 20. The use of a protective outer casing is optional but can be advantageous to protect the integrity of the ceramic thermal insulation layer in harsh environments such as very acidic or abrasive environments. While the ceramic thermal insulation layer 20 in the illustrated embodiment is applied only to the exterior surface of the inner liquid feed tube 14 in other embodiments it may be applied to other surfaces of the spray component. For example, in extremely high temperature environments it may be helpful to provide a second ceramic thermal insulation layer to another more outer surface of the spray component to provide additional protection against heat. Thus, the present invention is not limited to use of a ceramic thermal insulation layer on any particular surface or surfaces of a spray component.

In some embodiments such as with the illustrated spray gun there can be advantages to applying the ceramic thermal insulation layer 20 to the inner most tube or inner most fluid carrying body of the spray component. For example, in terms of the illustrated embodiment, it can be advantageous to apply the ceramic thermal insulation layer to either the inner liquid feed tube or to the exterior surface of the surrounding atomizing gas passageway. In particular, arranging the ceramic insulation layer as close to the fluid being sprayed as possible helps maintain the best internal environment for the fluid as it travels through the spray component while also shielding the fluid from the environment external to the spray component. For example, with illustrated spray gun 10 which can be used in sulfur injection applications, the ceramic thermal insulation layer 20 helps keep heat from the sulfur furnace chamber out of the spray gun 10, while also keeping the temperature of the liquid sulfur within the inner liquid feed tube 14 stable, so the liquid sulfur stays in its least viscous state for as long as possible. If liquid sulfur gets too cold or too hot, it can start to thicken and can clog the discharge nozzle 16.

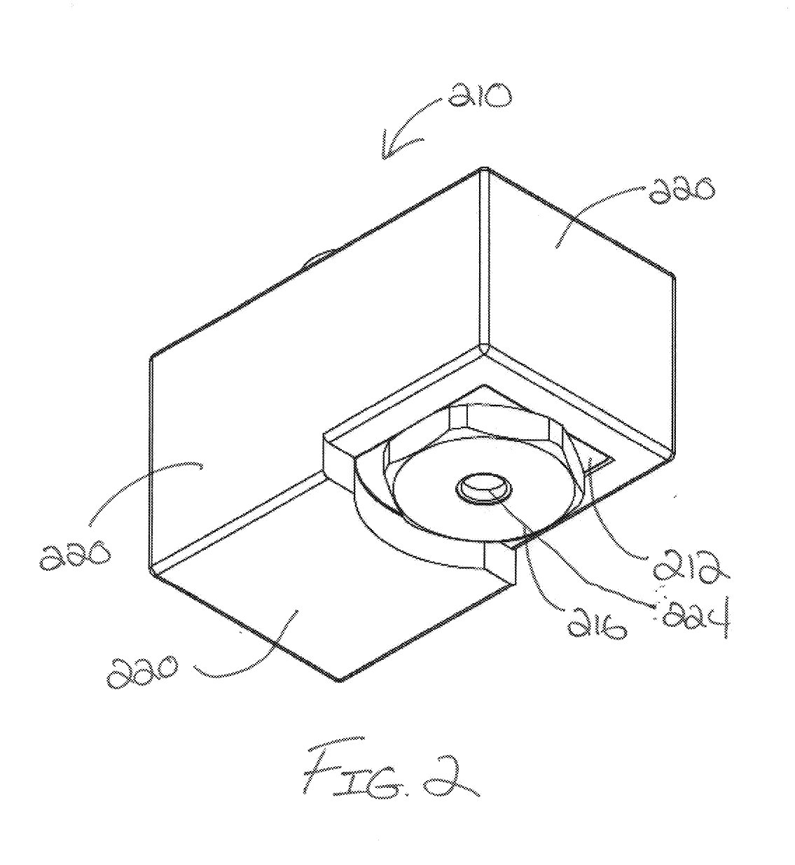

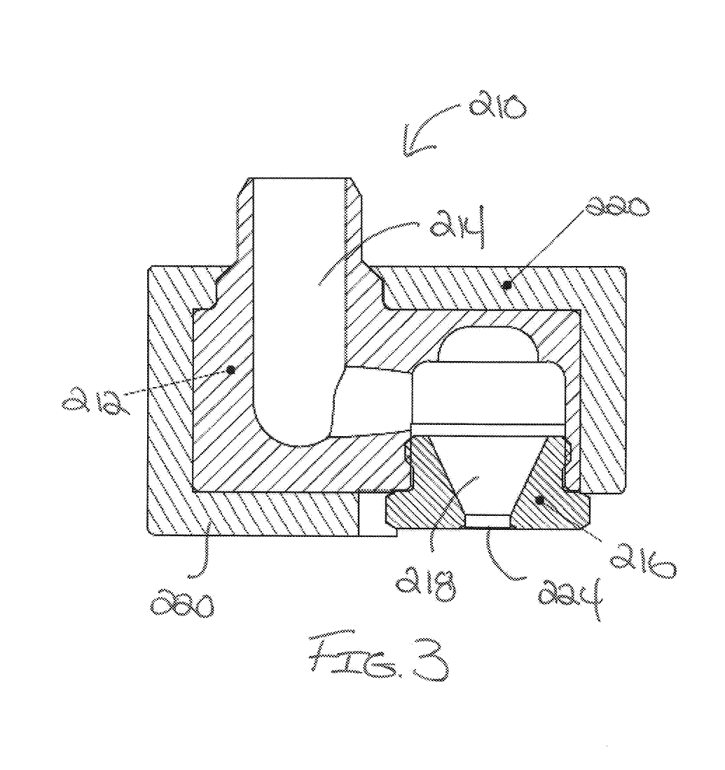

An alternative embodiment of a spray component having a ceramic thermal insulation layer according to the present disclosure is shown in FIGS. 2 and 3. In particular, the spray component of FIGS. 2-3 is in the form of a spray nozzle 210 that includes a nozzle body 212 and an interchangeable spray tip 216. As shown in FIG. 3, to allow for passage of fluid through the nozzle body 212, an internal fluid passageway 214 is provided in the nozzle body 212 that extends from a fluid inlet at an upstream end to a fluid outlet at a downstream end (the upstream and downstream ends are relative to the direction of fluid flow in the spray nozzle). In this case, the internal fluid passageway 214 has a generally L-shaped configuration and further features an expansion chamber adjacent the downstream end of the internal fluid passageway. It will be appreciated that the internal fluid passageway 214 could have other configurations than what is shown in FIG. 3. The spray tip 216 is arranged at the downstream end of the nozzle body 212. The spray tip 216 may be connected to the nozzle body 212 by a fastening mechanism, such as threads or a quick disconnect, that allows for the spray tip 216 to be readily attached and detached from the nozzle body 212 to allow for interchangeability of different spray tips with, for example, different discharge characteristics. In the illustrated embodiment, the spray tip 216 has a discharge passage 218 that at an upstream end communicates with the downstream end of the internal fluid passageway 214 in the nozzle body 212 and at a downstream end terminates in a discharge orifice 224. The illustrated discharge passageway 214 narrows as it extends in the downstream direction although other configurations also could be used.

In the embodiment of FIGS. 2 and 3, a ceramic thermal insulation layer 220 is provided on at least a portion of the outer or exterior surface of the nozzle body 212 that coincides with the majority of the length of the internal fluid passageway 214. This arrangement of the ceramic thermal insulation layer 220 helps protect the fluid in the internal fluid passageway 214 from the heat of the environment external to the nozzle body 212. In this case, the ceramic thermal insulation layer 220 is configured to provide an opening at the downstream end of the nozzle body to facilitate attachment and detachment of the spray tip 216.

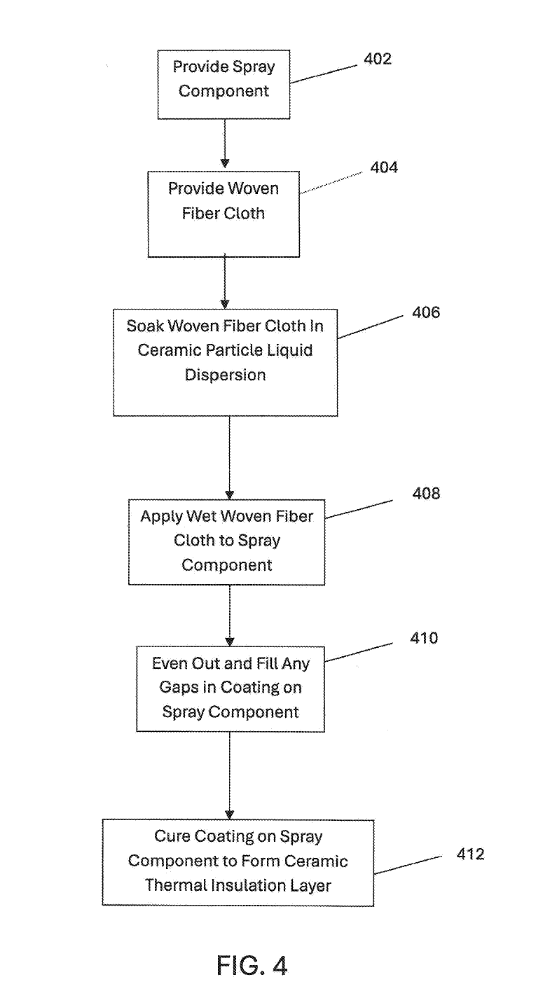

An exemplary process for producing the ceramic thermal insulation layer on a spray component is shown in the flow chart of FIG. 4. One known method for applying the liquid ceramic coating material utilizes a chopped strand fiberglass mat on which the liquid coating material is first dispersed. However, the chopped strands can become too structurally inconsistent for proper application to objects such as spray components. In particular, the mixture of chopped fiberglass and liquid coating material has the consistency and strength of wet tissue paper. This loose structure makes it difficult to keep the coating material in place long enough to cure on a spray component like a spray gun, lance or spray nozzle. This leads to the coating being applied at varying thickness across the spray component.

To alleviate these issues, the application method shown in FIG. 4 utilizes a woven fiberglass cloth. As shown in FIG. 4, in the first step 402, a spray component is provided. As previously discussed, the spray component can be any desired spray component including, for example, a spray gun, lance or a spray nozzle. In step 404, a woven fiber cloth such as a woven fiberglass cloth is provided, which may be in the form of a roll. Next, in step 406, the woven fiber cloth is soaked in the liquid ceramic coating material. In step 408, the wet woven fiber cloth is applied to the spray component by tightly wrapping the woven fiber cloth around portions of the spray component that may be exposed to excessive thermal energy. As necessary, in step 410, the coating on the spray component can be evened out and any gaps in the coating material may be addressed with a tool such as a brush which can be used to apply the liquid ceramic coating material. Next, in step 412, the liquid coating material is allowed to cure on the spray component to form the ceramic thermal insulation layer. For certain spray components or applications, one or more of steps 404-412 may be repeated as necessary in order to build up the ceramic thermal insulation layer to a desired thickness. In some embodiments, the thermal insulation layer may be applied so as to insulate the entirety of the spray component such as a spray gun or lance from the body of the lance to the tip of the nozzle on the lance. This ensures that no point on the final spray component assembly is unprotected. In some embodiments, a woven carbon fiber cloth material instead of a woven fiberglass cloth material may be used as the material to which the liquid ceramic coating material is applied.

Upon curing, the coating forms a thin, conforming thermal layer that forms a barrier that minimizes heat transfer to the internal flow path of the spray component, thereby reducing the risk of crystallization and clogging inside the spray component such as a lance or spray nozzle. The woven fibercloth provides an internal structure that holds the liquid ceramic material in place while it cures while also providing a consistent thickness around the spray component. Due to the added tensile strength and consistency of the woven fiber cloth, it provides superior performance for use in mass production without the need for molds or other specialized, custom equipment. The ceramic insulation coating material also provides additional durability to the spray component providing protection against dropping or other abuse. The surface to which the ceramic insulation coating material is applied can also provide sufficient durability for the application of a wrench or other tooling to the surface which is particularly advantageous with threaded spray components.

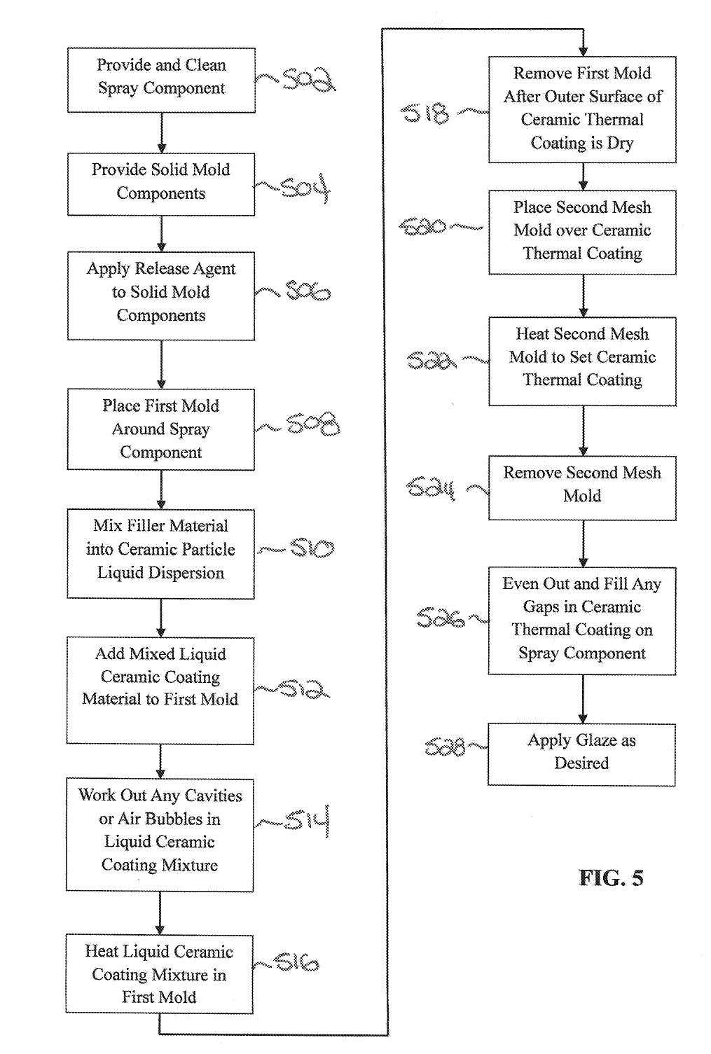

Another embodiment of a process for producing the ceramic thermal coating or layer on a spray component is shown in FIG. 5. It should be understood that the steps of the FIG. 5 method do not necessarily have to be performed in the order illustrated. The process illustrated in FIG. 5 uses two sets of molds to apply the ceramic thermal coating, a first mold uses a solid form to shape the ceramic thermal coating while a second mold uses a mesh form to facilitate the drying and setting of the ceramic thermal coating. It has been found that the liquid ceramic coating material dries from the outside in. As a result, difficulties can arise in drying the inner portions of the ceramic coating material. Once dried, the outer surface may not allow the permeation of the suspension liquid to the outside. The dried outer surface may also not permit the inner layer outgas to permeate through the dried outer layer. This can result in a ceramic thermal insulation layer with a dry outer shell and a still liquid interior. The two sets of molds help address these drying issues.

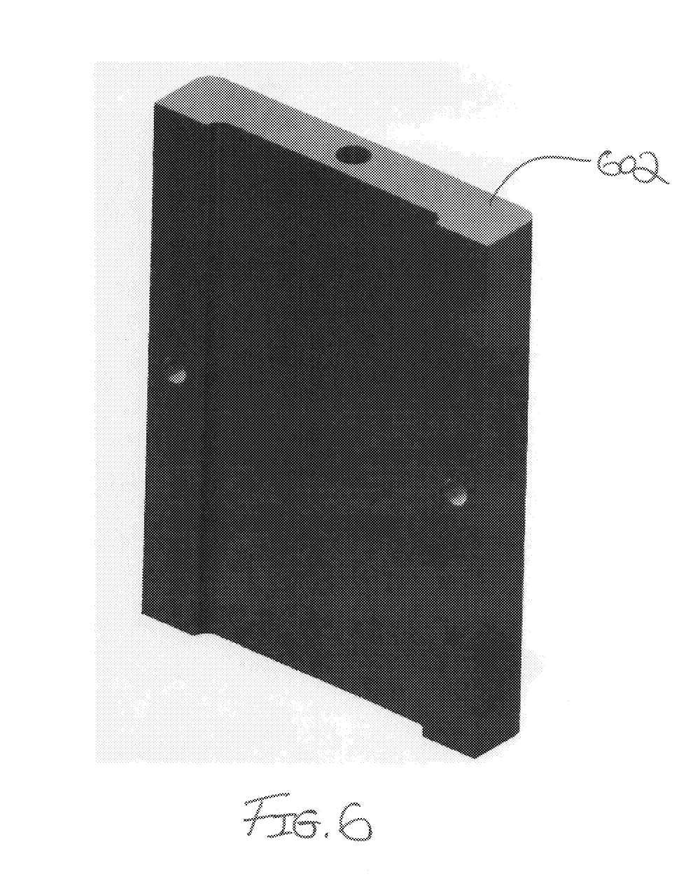

In a first step 502, a spray component is provided. To remove any oil, residue or debris, preparation of the spray component for molding may include soaking and/or cleaning of the spray component with a cleaning solution such as an acetone cleaner, isopropyl alcohol, and/or hot water with a degreasing soap. Once cleaned, the parts may be handled with gloved hands as oils from the skin can interfere with the molding process on smaller parts. Solid form mold components are provided in step 504 and the mold components are sprayed with a release agent, such as a silicone-based release agent, in step 506. When spraying the release agent, care should be taken to avoid applying release agent to the spray component. The first solid mold is constructed or placed around the spray component in step 508. The first solid mold may have at least one solid wall and be open on at least one side as described below. An exemplary solid mold component 602 is shown in FIG. 6.

To prepare the liquid thermal coating material, one or more fillers are added to ceramic particle liquid dispersion in step 510. For example, a fibrous filler material like fiberglass or carbon fiber or micro balloons (small glass spheres) are added to the ceramic particle liquid dispersion. If fibrous materials are used, the fibers should be cut into small strands of, for example, 0.250 inch or shorter. For fibrous materials, the filler and ceramic particle liquid dispersion may be mixed at a ratio of approximately 15% to approximately 35% filler to ceramic particle liquid dispersion by volume. The filler material should be mixed until the filler is well incorporated into the liquid. If micro balloons are used as the filler material, a ratio of approximately 40% to approximately 60% micro balloons to ceramic particle liquid dispersion by volume may be used.

In step 512, the mixed liquid ceramic coating material is added into the first mold. Any cavities or air bubbles in the liquid ceramic coating material mixture are worked out in step 514. For example, wooden sticks or the like may be used to work any large bubbles or voids out of the mixture. The mold may also be vibrated such as by being placed on a vibratory table to further work out any voids or air bubbles. Reduction or elimination of voids and air bubbles can increase the performance of the resultant ceramic thermal insulation layer.

The liquid ceramic coating mixture is dried in the first mold in step 516 by the application of heat. To facilitate drying, one side of the first mold can be left open to allow the inside to dry. For drying, the first mold can be placed in an oven at approximately 150° F for approximately 1 to approximately 3 hours until at least an outer surface of the ceramic thermal coating is sufficiently dry that the ceramic thermal coating can hold its shape. Then, the first mold is removed in step 518. The removal of the first mold can be performed one mold wall at a time.

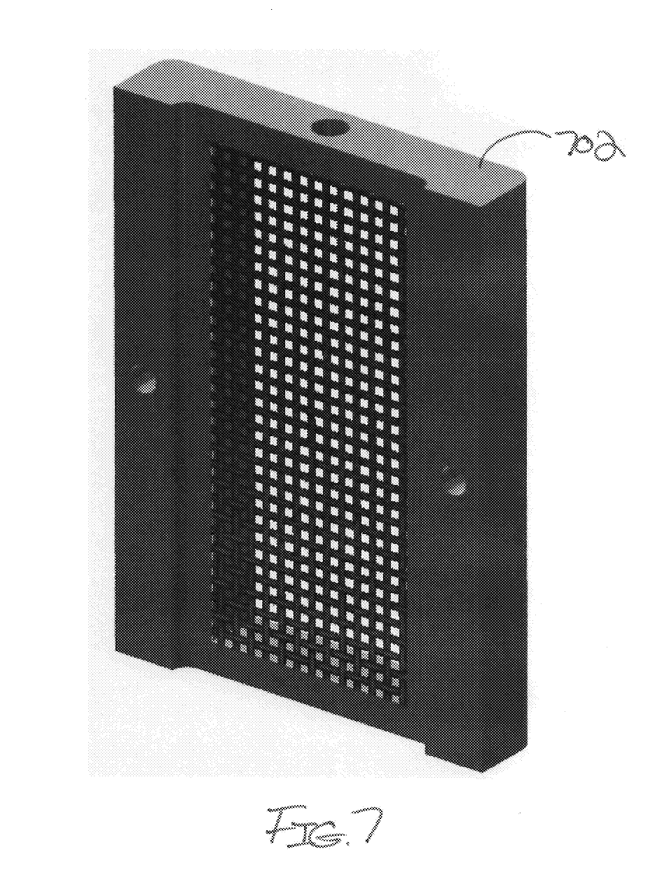

The first mold is replaced by a second mold in step 520. The second mold includes a mesh portion, such as a wire mesh, as part of a side wall of the mold to facilitate further drying and setting of the ceramic thermal insulation layer. The second wire mesh mold may be assembled so as to completely encapsulate the spray component without the open side present with the first mold. The wire mesh second mold provides enough support for the ceramic coating to hold its shape while allowing for the escape of outgases from the mold. An exemplary configuration of one second mold component 702 with a mesh portion is shown in FIG. 7. The second mold with the spray component is placed back into an oven for the application of heat to dry or set the ceramic thermal layer in step 522. For example, the second mold may be placed in an oven at, for example, approximately 180° F for approximately 8 to approximately 12 hours depending on the size and amount of ceramic thermal coating to set. A wicking material (e.g., string or paper) may be used with either the first or second mold to further help the drying of the inside portions of the ceramic thermal insulation layer.

Once the drying is done, the second mold may be removed in step 524. This may be accomplished by removing the second mold from the oven and allowing the second mold to cool. The spray component may then be slowly removed from the second mold. If there are any voids or cracked sections in the ceramic thermal insulation layer, liquid ceramic coating material can be applied to help fill in the voids or to re-bond cracks. Any voids may be filled with a syringe or similar device. Cracks will fill when brushed with liquid ceramic coating material. For example, the cracked or flacked area can be brushed several times to rewet the dried coating. Once wet, the new and old coatings will fuse to each other. Other surfaces may also be brushed with liquid ceramic coating material to help even out the surface. Prior to applying the liquid ceramic coating material, any residual release agent on the spray component should be removed. If any ceramic coating material needs to be removed, the surfaces with excess ceramic coating may be ground or sanded using anything from sandpaper to a grinding wheel depending on the amount of desired material to be removed. If desired, a glaze or secondary coating may be applied over the ceramic insulation layer. No special application or preparation is needed for the glazing process. The glaze or secondary coating can be applied simply using the manufacturer’s instructions.

Other alternative methods for applying the liquid ceramic coating material may also be used. Another application method may involve molding the liquid ceramic coating material into particular shapes for application to a spray component or around the spray component itself after the liquid ceramic coating material is molded. A process involving dipping the spray component in the liquid ceramic coating material also may be used. In such a dipping process, to prevent peeling of the coating material before curing, it may be necessary to apply a texture to the surface of the spray component such as by roughing up the surface prior to dipping. Additionally, or alternatively, the liquid ceramic material into which the spray component is dipped may be provided with an added reinforcing agent, like fiberglass, carbon fiber or micro balloons (small glass spheres). Another application method can involve the spraying of the liquid ceramic material onto the spray component. An easy spray-based application method would both ease the manufacturing process of insulating spray components such as lances and nozzles but also expand the usability of the ceramic insulation coating material into other types of spray products. For example, a sprayable installation of a ceramic thermal insulation layer may be used as a liner in a spray dryer machine. Any application method that allows for the formation of a ceramic thermal insulation layer on both uniform shapes like pipes and irregular or unconventional shapes like nozzles, nozzle heads and threads may be used.

In, for example, high temperature environments, the ceramic thermal insulation layer of the present invention helps preserve the integrity of the spray components and prevents thermal fouling thereby extending the operational life of the spray components and improving system reliability. The ceramic thermal insulation layer also enables more compact and flexible system design. More specifically, unlike traditional solutions such as steam jacketing systems, which are bulky, energy-intensive, and require complex fabrication and maintenance, the ceramic thermal insulation layer of the present invention offers a lightweight, low-maintenance alternative that can be applied quickly using minimal equipment.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A method for applying an insulation layer to a spray component comprising the steps of:
providing a first mold in the shape of at least a portion of the spray component, the first mold having at least one solid wall and being open on at least one side;
mixing at least one filler into a ceramic particle liquid dispersion to produce a ceramic particle liquid mixture, the filler comprising a fibrous material or glass micro balloons;
adding the ceramic particle liquid mixture into the first mold;
applying heat to the ceramic particle liquid mixture in the first mold;
removing the first mold after an outer surface portion of a ceramic thermal insulation layer has dried;
placing a second mold over the ceramic thermal insulation layer, the second mold having at least one wall comprising a mesh portion;
applying heat to the ceramic thermal insulation layer and the second mold until the ceramic thermal insulation layer sets; and
removing the second mold from the spray component.

2. The method according to claim 1 wherein the filler is a fibrous material consisting of fibers having a length of 0.25 inch or shorter.

3. The method according to claim 2 wherein the filler is a fibrous material and the ceramic particle mixture is mixed at a ratio of 15% to 35% filler to ceramic particle liquid dispersion by volume.

4. The method according to claim 1 wherein the filler is glass micro ballons and the ceramic particle mixture is mixed at a ratio of 40% to 60% filler to ceramic particle liquid dispersion by volume.

5. The method according to claim 1 further including the step of vibrating the first mold after the first mold is filled with the ceramic particle liquid mixture and before applying heat to the ceramic particle liquid mixture in the first mold.

6. The method according to claim 1 further including the step of brushing at least a portion of the ceramic insulation layer with the ceramic particle liquid mixture after removing the second mold.

7. The method according to claim 1 further including the step of applying a release agent to the first mold prior to adding the ceramic particle liquid mixture to the first mold.

8. The method according to claim 1 wherein the first mold and the ceramic particle liquid mixture are heated to approximately 150° F for one to three hours.

9. The method according to claim 1 wherein the second mold is heated to approximately 180° F for eight to twelve hours.

10. A method for applying an insulation layer to a spray component comprising the steps of:
soaking a woven fiberglass cloth in a ceramic particle liquid dispersion;
applying the wet woven fiberglass cloth to a surface of the spray component; and
curing the wet woven fiberglass cloth on the spray component surface to form a ceramic thermal insulation layer on the surface of the spray component.

11. The method according to claim 10 wherein the wet woven fiberglass cloth is applied in a first layer and further including the step of applying a second layer of wet woven fiberglass cloth over the first layer.

12. The method according to claim 10 further including the step of brushing at least a portion of the ceramic insulation layer with the ceramic particle liquid dispersion after removing curing of the wet woven fiberglass cloth on the spray component.

13. A spray component comprising:
a body including an internal fluid passageway, the internal fluid passageway communicating at one end with a discharge orifice; and
a ceramic thermal insulation layer arranged on an external surface of the body, the ceramic thermal insulation layer being a liquid applied ceramic particle dispersion having at least one filler from the group consisting of a fibrous material and glass micro balloons.

14. The spray component according to claim 13 wherein the fibrous material is fiberglass.

15. The spray component according to claim 13 wherein the fibrous material is carbon fiber.

16. The spray component according to claim 13 wherein the filler is a fibrous material consisting of fibers having a length of 0.25 inch or shorter.

17. The spray component according to claim 16 wherein the filler is a fibrous material and the ceramic particle mixture is mixed at a ratio of 15% to 35% filler to ceramic particle liquid dispersion by volume.

18. The spray component according to claim 13 wherein the filler is glass micro ballons and the ceramic particle mixture is mixed at a ratio of 40% to 60% filler to ceramic particle liquid dispersion by volume.

19. The spray component according to claim 13 wherein the body is an inner liquid feed tube arranged in a housing.

20. The spray component according to claim 13 wherein the body is a nozzle body with an attached spray tip.
